(19) United States
(12) Patent Application Publication
(10) Pub. No.: US 2006/0081817 A1
(43) Pub. Date: Apr. 20, 2006

(54) Conductive adhesive composition

(75) Inventors: Takashi Shinohara, Suwa-shi (JP); Yuji Shinohara, Suwa-shi (JP); Koichi Terao, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/235,358

(22) Filed: Sep. 27, 2005

(30) Foreign Application Priority Data
Oct. 18, 2004 (JP) 2004-302467

(51) Int. Cl. H01B 1/12; H01B 1/00

(52) U.S. Cl. 252/500

(57) ABSTRACT

Aspects of the invention can provide a conductive adhesive composition which can include a compound represented by the following general formula (1): 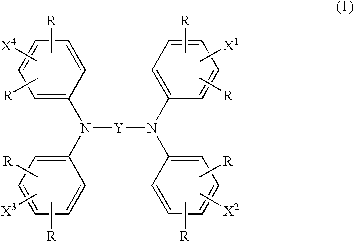
wherein X¹, X², X³ and X⁴, each independently represent a hydrogen atom or a straight-chain alkyl group, which may be the same or different; however, at least one of X¹, X², X³ and X⁴ represents a straight-chain alkyl group having carbon number of 3 to 8, and the rest represents a hydrogen atom, a methyl group or an ethyl group; also, R at eight positions each independently represents a hydrogen atom, a methyl group or an ethyl group, which may be the same or different; and Y represents a group including at least one substituted or unsubstituted aromatic hydrocarbon ring.

### INCORPORATION BY REFERENCE

This application claims the benefit of Japanese Patent Application No. 2004-302467, filed Oct. 18, 2004. The entire disclosure of the prior application is hereby incorporated by reference herein in its entirety.

### BACKGROUND

Aspects of the invention can relate to a conductive adhesive composition. In various types of devices, related art conductive adhesive compositions may be used for jointing a member to another constituting a conductive part. This related art conductive adhesive composition can be prepared by mixing conductive particles, such as metal particles or carbon particles with a resin binder.

In order to electrically connect the members using such a conductive adhesive composition, in general, the members must be brought into close access by pressing one member against another in the state of a conductive adhesive composition interposed between these members, until both members are electrically connected via the conductive particles that are present in the conductive adhesive composition. See, for example, JP-A-2003-45235.

However, in case where a member having comparatively weak mechanical strength is used as the member to be jointed, there can arise problems of disruption of the member itself because it can not withstand the pressure when one member is pressed against another member. In order to solve such problems, it is expected that achieving conductivity and adhesiveness without using conductive particles, i.e., presence of an adhesive composition which exerts conductivity in itself, would be beneficial. However, such a conductive adhesive composition has not been found under current conditions.

### SUMMARY

An aspect of the invention can provide a conductive adhesive composition that is excellent in conductivity and adhesiveness, without using other additive. Such an advantage can be achieved by the following aspect of the invention.

A conductive adhesive composition according to an aspect of the invention can include a compound represented by the following general formula (1): 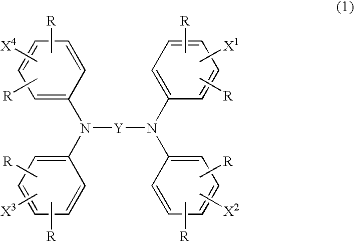
wherein X¹, X², X³ and X⁴, each independently represent a hydrogen atom or a straight-chain alkyl group, which may be the same or different. However, at least one of X¹, X², X³ and X⁴ represents a straight-chain alkyl group having carbon number of 3 to 8, and the rest represents a hydrogen atom, a methyl group or an ethyl group; also, R at eight positions each independently represents a hydrogen atom, a methyl group or an ethyl group, which may be the same or different, and Y represents a group including at least one substituted or unsubstituted aromatic hydrocarbon ring. Accordingly, adhesive layers formed of the conductive adhesive composition according to an aspect of the invention achieves excellent conductivity and adhesiveness without using other additive.

In the conductive adhesive composition according to an aspect of the invention, two substituents among the substituent X¹, the substituent X², the substituent X³ and the substituent X⁴ preferably represent a straight-chain alkyl group having carbon number of 3 to 8. Accordingly, the adhesive layer achieves excellent adhesiveness.

In the conductive adhesive composition according to an aspect of the invention, the substituent X¹ and the substituent X³ preferably can represent a straight-chain alkyl group having carbon number of 3 to 8. Accordingly, the adhesive layer achieves the adhesiveness more suitably.

In the conductive adhesive composition according to an aspect of the invention, the substituents representing a straight-chain alkyl group having carbon number of 3 to 8 among the substituent X¹, the substituent X², the substituent X³ and the substituent X⁴ preferably have the same carbon number. Accordingly, occurrence of deviation of electric conductivity at each part of the adhesive layer can be suitably prevented. In other words, more uniform conductivity can be provided at each part of the adhesive layer.

In the conductive adhesive composition according to an aspect of the invention, three substituents among the substituent X¹, the substituent X², the substituent X³ and the substituent X⁴ preferably can represent a straight-chain alkyl group having carbon number of 3 to 8. Accordingly, the adhesive layer achieves more excellent adhesiveness.

In the conductive adhesive composition according to an aspect of the invention, the substituents having a straight-chain alkyl group having carbon number of 3 to 8 among the substituent X¹, the substituent X², the substituent X³ and the substituent X⁴ preferably have the same carbon number. Accordingly, occurrence of deviation of electric conductivity at each part of the adhesive layer can be suitably prevented. In other words, more uniform conductivity can be provided at each part of the adhesive layer.

In the conductive adhesive composition according to an aspect of the invention, all of the substituent X¹, the substituent X², the substituent X³ and the substituent X⁴ preferably represent a straight-chain alkyl group having carbon number of 3 to 8. Accordingly, the adhesive layer can achieve excellent adhesiveness.

In the conductive adhesive composition according to an aspect of the invention, all of the substituent X¹, the substituent X², the substituent X³ and the substituent X⁴ preferably have the same carbon number. Accordingly, occurrence of deviation of electric conductivity at each part of the adhesive layer can be suitably prevented. In other words, more uniform conductivity can be provided at each part of the adhesive layer.

In the conductive adhesive composition according to an aspect of the invention, the substituent X¹, the substituent X², the substituent X³ and the substituent X⁴ preferably bind to either one of the position 3, position 4 or position 5 of the benzene ring, respectively. Accordingly, the adhesive layer can achieve excellent conductivity and adhesiveness.

In the conductive adhesive composition according to an aspect of the invention, the group Y can preferably be constituted from a carbon atom and a hydrogen atom. Accordingly, electron transfer between the molecules of the compound represented by the above general formula (1) can be executed without fail. Thus, the conductive adhesive composition according to an aspect of the invention achieves excellent conductivity in the state of forming the adhesive layer.

In the conductive adhesive composition according to an aspect of the invention, the group Y preferably has total carbon number of 6 to 30. Accordingly, electron transfer between the molecules of the compound represented by the above general formula (1) can be executed more certainly. Thus, the adhesive layer achieves more excellent adhesiveness.

In the conductive adhesive composition according to an aspect of the invention, number of the aromatic hydrocarbon ring in the group Y is preferably 1 to 5. Accordingly, electron transfer between the molecules of the compound represented by the above general formula (1) can be executed more certainly. Thus, the adhesive layer can achieve excellent adhesiveness.

In the conductive adhesive composition according to an aspect of the invention, the group Y is preferably a biphenylene group or a derivative thereof. Accordingly, electron transfer between the molecules of the compound represented by the above general formula (1) can be executed more certainly. Thus, the adhesive layer can achieve excellent adhesiveness.

In the conductive adhesive composition according to an aspect of the invention, the compound preferably has a melting point of 60 to 150° C. Accordingly, the members to be jointed can be suitably prevented from undesirable alteration and deterioration by heating, because the temperature for heating the solid matter can be lowered in case where the conductive adhesive composition according to an aspect of the invention is used as a solid matter.

In the conductive adhesive composition according to an aspect of the invention, the compound preferably has a glass transition temperature of 5 to 30° C. Accordingly, operation upon jointing the members to be jointed can be readily carried out in case where the conductive adhesive composition according to an aspect of the invention is used as a solid matter. Thus, the members can be jointed without fail.

The conductive adhesive composition according to an aspect of the invention can preferably used as a solid matter comprising the compound as a principal component. Accordingly, contamination of impurities in the formed adhesive layer can be suitably suppressed or prevented.

In the conductive adhesive composition according to an aspect of the invention, the solid matter preferably achieves adhesiveness upon heating. Accordingly, the members to be jointed can be jointed without fail.

In the conductive adhesive composition according to an aspect of the invention, it is preferred that the compound is dissolved in a solvent, and is used as a liquid matter or a semisolid matter. Accordingly, the conductive adhesive composition can be comparatively readily fed to the face of the members to be jointed on the side of the joint.

In the conductive adhesive composition according to an aspect of the invention, it is preferred that the liquid matter and the semisolid matter achieve adhesiveness through removal of at least a part of the solvent. Accordingly, the members to be jointed can be jointed without fail.

In the conductive adhesive composition according to an aspect of the invention, content of the compound in the liquid matter and the semisolid matter is preferably 1 to 50 wt %. Accordingly, the liquid or semisolid conductive adhesive composition can be prepared to exhibit comparatively low viscosity, and the viscosity can be rapidly elevated upon removal of the solvent.

### BRIEF DESCRIPTION OF THE DRAWINGS

The invention will be described with reference to the accompanying drawings, wherein like numbers reference like elements, and wherein:

FIG. 1 is a schematic diagram (vertical sectional view) showing a state of joint by the conductive adhesive composition according to the invention between a terminal mounted on a circuit board and a terminal mounted on an electronic part;

FIGS. 2A to 2C are schematic views (vertical sectional views) for illustrating a method of jointing by the conductive adhesive composition according to the invention between a terminal mounted on a circuit board and a terminal mounted on an electronic part;

FIGS. 3A and 3B are schematic views (vertical sectional views) illustrating a method of jointing by the conductive adhesive composition according to the invention between a terminal mounted on a circuit board and a terminal mounted on an electronic part;

FIG. 4 is a schematic diagram (perspective view) showing a board having a gold electrode; and

FIG. 5 is a schematic diagram (vertical sectional view) showing a test piece for use in an adhesiveness test and a conductivity test.

### DETAILED DESCRIPTION OF EMBODIMENTS

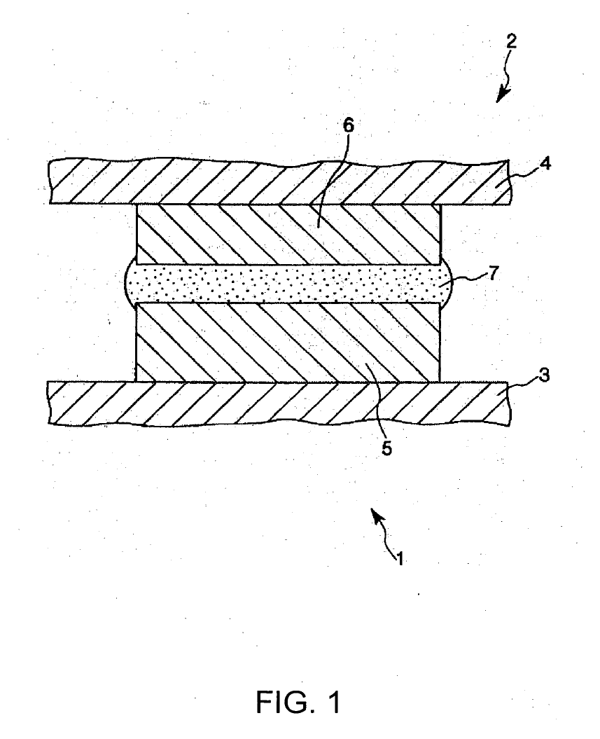

Hereinafter, the conductive adhesive composition according to the invention will be explained in detail with reference to exemplary embodiments. A conductive adhesive composition according to the invention can be used for electrically connecting a terminal 5 mounted on a circuit board 1 to a terminal 6 mounted on an electronic part 2 as shown in FIG. 1, for example.

FIG. 1 is a schematic diagram (vertical sectional view) showing a state of joint by the conductive adhesive composition of the invention between a terminal mounted on a circuit board and a terminal mounted on an electronic part.

As shown in FIG. 1, the circuit board 1 has a board 3 with wiring (not shown in the Figure), and the terminal 5 connected to the end of the wiring. Further, the electronic part 2 has a board 4 having an active element (not shown in the Figure), and the terminal 6 connected to the end of the active element. Furthermore, the terminal 5 and the terminal 6 are jointed and electrically connected by allowing an adhesive layer 7 formed of the conductive adhesive composition of the invention to be interposed between the terminal 5 and the terminal 6 to be connected.

The conductive adhesive composition of the invention can include a compound represented by the following general formula (1): 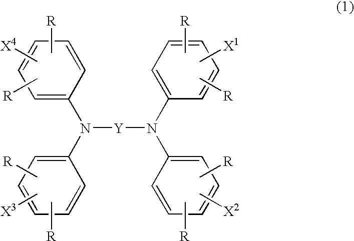
wherein X¹, X², X³ and X⁴, each independently represent a hydrogen atom or a straight-chain alkyl group, which may be the same or different. However, at least one of X¹, X², X³ and X⁴ represents a straight-chain alkyl group having carbon number of 3 to 8, and the rest represents a hydrogen atom, a methyl group or an ethyl group; also, R at eight positions each independently represents a hydrogen atom, a methyl group or an ethyl group, which may be the same or different, and Y represents a group including at least one substituted or unsubstituted aromatic hydrocarbon ring.

It has been found that the compound represented by the above general formula (1) exhibits high conductivity and that high adhesiveness has come to be achieved by subjecting to a given treatment.

The conductive adhesive composition of the invention can be used as, for example: [1] a solid matter including the compound represented by the above general formula (1) (hereinafter, merely referred to as “compound (1)”) as a principal component; or [2] a liquid matter or a semisolid matter prepared by dissolving the compound (1) in a solvent.

Solidification, or elevation of the viscosity to be higher than that in the state when the composition was fed between the terminal 5 and the terminal 6 can be perfected by: heating followed by cooling of the solid matter, in cases of the above example [1]; or removing a part or all of the solvent included in the liquid matter or the semisolid matter, in cases of the above example [2]. Accordingly, the adhesive layer 7 is formed between the terminal 5 and the terminal 6 which are jointed via the adhesive layer 7.

In the compound (1), at least one, preferably two, more preferably three, still more preferably four substituents among the substituent X¹, the substituent X², the substituent X³ and the substituent X⁴ (hereinafter, these may be collectively referred to as “substituent X”) may be a straight-chain alkyl group having carbon number of 3 to 8.

Introduction of the straight-chain alkyl group having carbon number of 3 to 8, and increase in number of the introduced group may result in lowering of the melting point and glass transition temperature of the compound (1). Also, because interaction between the substituents X is caused, crystallization of this compound has come to be suppressed. Thus, the compound becomes apt to turn into the amorphous state. Accordingly, the adhesive layer 7 has come to achieve excellent adhesiveness.

Furthermore, because main skeleton of the compound (1) has a conjugated chemical structure, smooth electron transfer may be executed between the molecules of the compound, owing to specific spread of the electron cloud thereof. Accordingly, the adhesive layer 7 has come to achieve excellent conductivity. Therefore, the adhesive layer 7 formed of the conductive adhesive composition of the invention without need of adding other additive such as conductive particles has come to achieve both excellent conductivity and excellent adhesiveness.

Moreover, the straight-chain alkyl group more preferably has carbon number of 3 to 6. When the carbon number of the straight-chain alkyl group is too small, interaction between the substituents X becomes so low that the compound (1) that hardly turns into its amorphous state may be provided. Consequently, the adhesive layer 7 may not achieve sufficient adhesiveness. To the contrary, when the carbon number of the straight-chain alkyl group is too great, access of main skeletons of the compound (1) in the adhesive layer 7 becomes so difficult that sufficient conductivity may not be attained.

In other words, by setting the carbon number of the straight-chain alkyl group to fall within the above range, the interaction between adjacent substituents X may be more certainly caused, and the electron transfer between the main skeletons can be more certainly executed. Consequently, the adhesive layer 7 formed of the conductive adhesive composition of the invention has come to achieve both conductivity and adhesiveness more suitably.

In addition, when two substituents among the substituents X are a straight-chain alkyl group having carbon number of 3 to 8, it is preferred that the substituent X¹ and the substituent X³ are a straight-chain alkyl group having carbon number of 3 to 8. Accordingly, the interaction between the substituents X may be more certainly caused. Thus, the adhesive layer 7 has come to more suitably achieve the adhesiveness.

Further, when multiple substituents among the substituents X are a straight-chain alkyl group having carbon number of 3 to 8, each substituent X preferably has approximately the same carbon number, and more preferably has the same carbon number. Accordingly, occurrence of variance of the clearance distances between the molecules of the compound (1), i.e., the main skeletons, in the adhesive layer 7 can be suitably prevented or suppressed. Consequently, occurrence of deviation of electric conductivity at each part of the adhesive layer 7 can be suitably prevented. In other words, more uniform conductivity can be provided at each part of the adhesive layer 7 formed of the conductive adhesive composition of the invention.

Although the substituent X may be bound to any position of from the position 2 to the position 6 of the benzene ring, binding to any one of the position 3, position 4 or position 5 is preferred, in particular. Accordingly, interaction between the substituents X may be more certainly caused, and the molecules of the compound (1) can be kept away by more adequate distance. Accordingly, the adhesive layer 7 has come to achieve more excellent conductivity and adhesiveness.

Among the substituents X, those other than the straight-chain alkyl group having carbon number of 3 to 8 represent a hydrogen atom, a methyl group or an ethyl group, however, selection of them may be conducted according to the carbon number the substituent X representing the straight-chain alkyl group having carbon number of 3 to 8. For example, when the substituent X representing the straight-chain alkyl group having carbon number of 3 to 8 has a great carbon number, a hydrogen atom may be selected for the rest. To the contrary, when the substituent X representing the straight-chain alkyl group having carbon number of 3 to 8 has a small carbon number, a methyl group or an ethyl group may be selected for the rest.

Moreover, the compound (1) preferably has a melting point of approximately 60 to 150° C., and more preferably approximately 60 to 100° C. Accordingly, the circuit board 1, the electronic part 2 and the like can be suitably prevented from undesirable alteration and deterioration by heating, because the temperature of the heating can be lowered when the terminal 5 and the terminal 6 are jointed by the adhesive layer 7 in case where the conductive adhesive composition of the invention is used as a solid matter.

Moreover, the compound (1) preferably has a glass transition temperature of approximately 1 to 30° C., and more preferably approximately 5 to 20° C. Accordingly, in case where the conductive adhesive composition of the invention is used as the solid matter, solidification thereof can be prevented at a relatively low temperature, and the supercooling state with adhesiveness can be maintained after melting the solid matter through heating. Consequently, operation upon connection between the terminal 5 and the terminal 6 can be more readily carried out, and they can be jointed without fail.

Next, main skeleton that is responsible for electron transfer (electric conduction) in the compound (1) will be explained. The substituent R may be a hydrogen atom, a methyl group or an ethyl group, and the substituent R may be also selected depending on the carbon number of the substituent X. For example, a hydrogen atom is selected for the substituent R in case where the substituent X has a great carbon number, while a methyl group or an ethyl group may be selected for the substituent R in case where the substituent X has a small carbon number.

The group Y may include at least one substituted or unsubstituted aromatic hydrocarbon ring, however, one constituted from a carbon atom and a hydrogen atom is particularly preferred. Accordingly, electron transfer between the molecules of the compound (1) can be executed more certainly. Therefore, the adhesive layer 7 has come to achieve excellent conductivity. Specific examples of the structure including at least one aromatic hydrocarbon ring include e.g., those represented by the following chemical formulae (2) to (18).

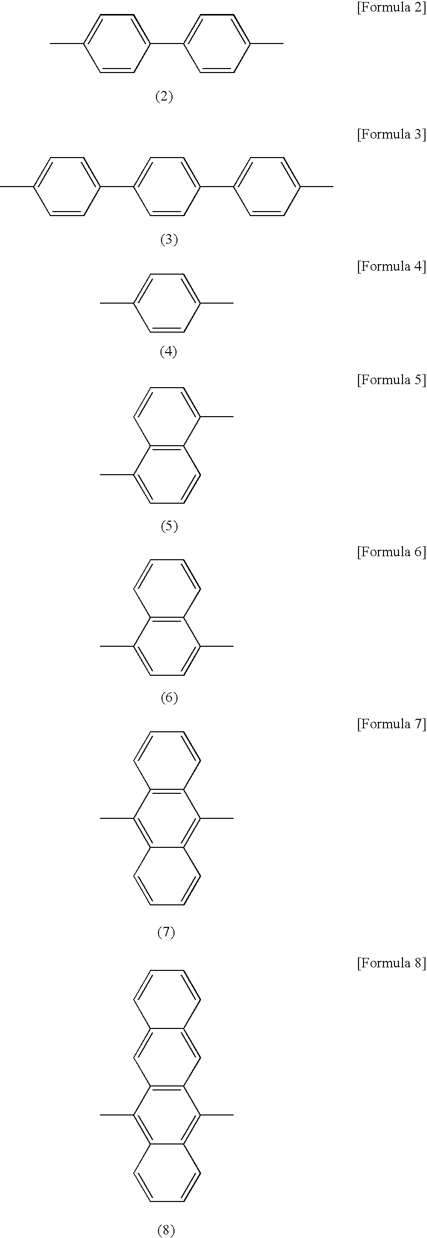

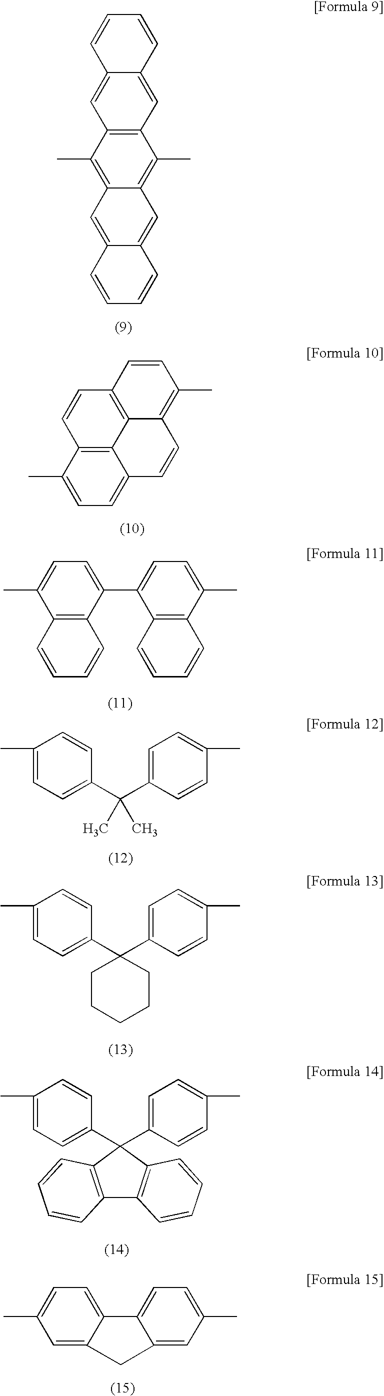

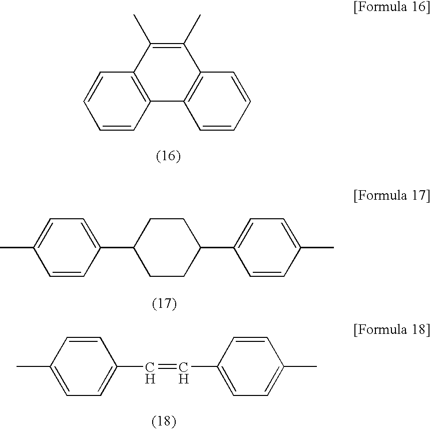

In addition, the group Y has total carbon number of preferably 6 to 30, more preferably 10 to 25, and still more preferably 10 to 20. Further, the group Y has number of the aromatic hydrocarbon ring of preferably 1 to 5, more preferably 2 to 5, and still more preferably 2 or 3. In these respects, particularly preferable group Y has a structure of a biphenylene group or a derivative thereof in the compound (1). Accordingly, electron transfer between the molecules of the compound (1) can be executed more certainly. Thus, the adhesive layer 7 formed of the conductive adhesive composition of the invention has come to achieve excellent conductivity.

Also, when a substituent is introduced into the aromatic hydrocarbon ring in the group Y, this substituent is not particularly limited as long as planarity of the group Y can be retained, but a straight-chain alkyl group having carbon number of 1 to 3 is preferred, and a methyl group or an ethyl group is more preferred.

Additionally, mean thickness of the adhesive layer 7 is not particularly limited, but it is preferably approximately 0.01 to 1.0 μm, and more preferably approximately 0.05 to 0.1 μm. Accordingly, the adhesive layer 7 can achieve sufficient conductivity while preventing decline of the adhesiveness.

Moreover, the adhesive layer 7 has an adhesive strength of preferably 0.001 MPa or greater, and more preferably 0.01 MPa or greater. Accordingly, even in the case where external stress is imparted against the jointed member of the terminal 5 and the terminal 6 in the jointed state, detachment thereof can be certainly prevented or reduced.

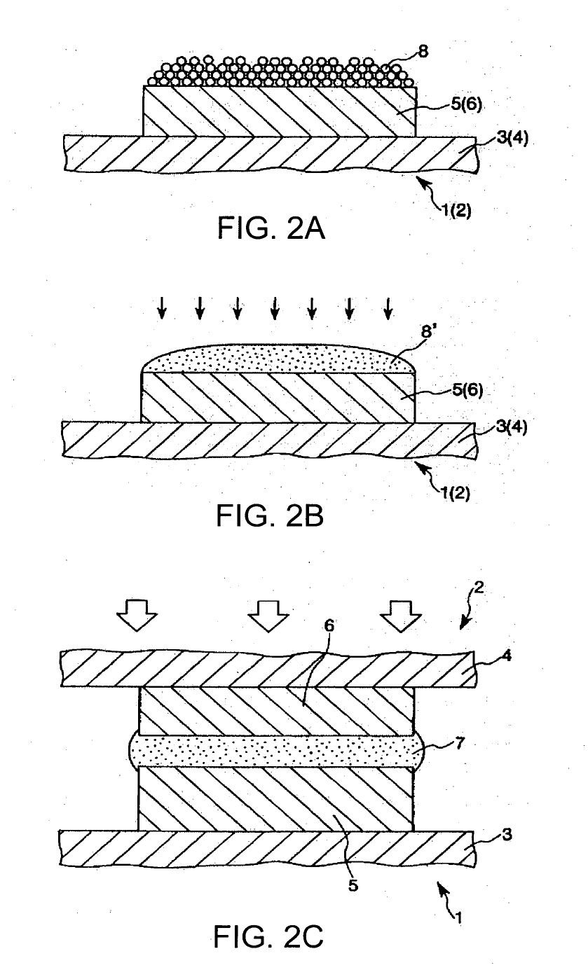

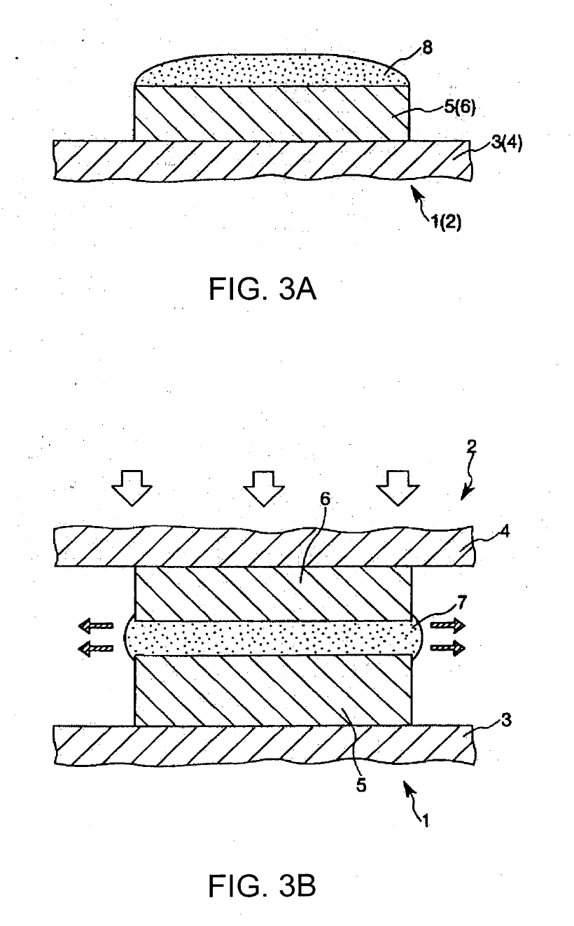

Next, specific method of jointing the terminal 5 and the terminal 6 through forming the adhesive layer 7 of the conductive adhesive composition of the invention will be explained. FIGS. 2A to 2C and FIGS. 3A and 3B are schematic views (vertical sectional views) for illustrating a method of jointing by the conductive adhesive composition according to the invention between a terminal mounted on a circuit board and a terminal mounted on an electronic part, respectively. Hereinafter, upper side will be referred to as “up”, and “bottom side” will be referred to as “bottom” in FIGS. 2A to 2C and FIGS. 3A and 3B.

[1] Use of the Conductive Adhesive Composition As a Solid Matter

Shape of a solid conductive adhesive composition 8 is not particularly limited, but for example, may be any one of powder, granule, small mass and the like.

[1-1] First, the solid conductive adhesive composition 8 is fed on the upper face of the terminal 5 and the upper face of the terminal 6 (see, FIG. 2A). The conductive adhesive composition 8 may be fed on the upper face of either one of the terminal 5 or the terminal 6.

[1-2] Next, the conductive adhesive composition 8 is heated and melted using, for example, an electric heater, an infrared heater or the like. Accordingly, the conductive adhesive composition 8 becomes a semisolid matter 8′ having adhesiveness, and adheres on the upper face of the terminal 5 and the terminal 6 (see, FIG. 2B). Use of the compound (1) having a comparatively low melting point as described above in this step can certainly prevent the circuit board 1, the electronic part 2 and the like from unnecessary heat applied thereto. Therefore, the circuit board 1, the electronic part 2 and the like can be suitably prevented from undesirable alteration and deterioration.

[1-3] Next, the semisolid matter 8′ is interposed between the terminal 5 and the terminal 6 through bringing the circuit board 1 and the electronic part 2 into access while positioning the terminals 5 and 6 to be jointed. When the circuit board 1 and the electronic part 2 are brought into access, the electronic part 2 may be pressed against the circuit board 1 as needed. Use of the conductive adhesive composition of the invention 8 for the joint between the terminal 5 and the terminal 6 can suitably prevent the terminal 5 (circuit board 1) and the terminal 6 (electronic part 2) from disruption because great pressure is not required even in such cases where the electronic part 2 is pressed.

[1-4] Next, the semisolid matter 8′ (conductive adhesive composition 8 in the melted state) is cooled to solidify or elevate its viscosity. Accordingly, the terminal 5 and the terminal 6 can be jointed, thereby forming the adhesive layer 7 between the terminal 5 and the terminal 6 (see, FIG. 2C). Through using the compound (1) having a comparatively low glass transition temperature as described above, the conductive adhesive composition 8 melted by heating can maintain a supercooling state accompanied by adhesiveness at a comparatively low temperature, i.e., the state of semisolid matter 8′. Thus, operation for jointing the terminal 5 and the terminal 6 can be readily carried out. Also, because the conductive adhesive composition 8 comprises the compound (1) as a principal component, contamination of impurities in the formed adhesive layer 7 can be suitably suppressed or prevented in this method.

[2] Use of the Conductive Adhesive Composition As a Liquid Matter or a Semisolid Matter

Liquid or semisolid prepared by dissolving the compound (1) in a solvent is used as the conductive adhesive composition 8. In this state, the compound (1) has been believed to be present in an amorphous state through moderate interaction between the substituents X in the conductive adhesive composition 8. In addition, because the compound (1) exhibits high solubility in the solvent, the viscosity of the liquid or semisolid conductive adhesive composition 8 can be comparatively readily adjusted by setting the content of the compound (1) in the conductive adhesive composition 8.

Then, by adjusting the viscosity of the conductive adhesive composition 8 to be comparatively low, it can be comparatively readily fed on the upper face of the terminal 5 or the terminal 6, with favorable operativity in the step [2-1]. Specifically, content of the compound (1) in the conductive adhesive composition 8 is preferably 1 to 50 wt %, and more preferably 10 to 30 wt %. Accordingly, the conductive adhesive composition 8 can be adjusted to exhibit a relatively low viscosity, and the viscosity thereof can be rapidly elevated when the solvent is removed.

The solvent for dissolving the compound (1) is not particularly limited, and examples thereof include e.g., various organic solvents such as: ether solvents, such as methyl ethyl ketone (MEK), diethyl ether, diisopropyl ether, 1,2-dimethoxyethane (DME), 1,4-dioxane, tetrahydrofuran (THF), tetrahydropyran (THP), anisole, diethylene glycol dimethyl ether (diglyme) and diethylene glycol ethyl ether (Carbitol); cellosolve solvents, such as methyl cellosolve, ethyl cellosolve and phenyl cellosolve; aliphatic hydrocarbon solvents such as hexane, pentane, heptane, and cyclohexane; aromatic hydrocarbon solvents such as toluene, xylene and benzene; aromatic heterocyclic compound based solvents such as pyridine, pyrazine, furan, pyrrole, thiophene and methyl pyrrolidone; amide solvents such as N,N-dimethyl formamide (DMF) and N,N-dimethyl acetamide (DMA); halogen compound based solvents, such as dichloromethane, chloroform and 1,2-dichloroethane; ester solvents such as ethyl acetate, methyl acetate and ethyl formate; sulfur compound based solvents such as dimethyl sulfoxide (DMSO), and sulfolane; nitrile solvents, such as acetonitrile, propionitrile and acrylonitrile; and organic acid solvents, such as formic acid, acetic acid, trichloroacetic acid and trifluoroacetic acid; or mixed solvents including them and the like. In addition, the examples include mixed solvents of one or more of these various organic solvents, and one or more polar solvents such as: ketone solvents, such as acetone, diethyl ketone, methyl isobutyl ketone (MIBK), methyl isopropyl ketone (MIPK) and cyclohexanone; and alcohol solvents, such as methanol, ethanol, isopropanol, ethylene glycol, diethylene glycol (DEG) and glycerol; and the like.

[2-1] First, the conductive adhesive composition 8 is coated (fed) on the upper face of the terminal 5 and the upper face of the terminal 6 (see, FIG. 3A). For the coating, any of a variety of coating methods such as spin coating, casting, micro gravure coating, gravure coating, bar coating, roll coating, wire bar coating, dip coating, spray coating, screen printing, flexo printing, offset printing and ink jet printing. The conductive adhesive composition 8 may be fed on only the upper face of either one of the terminal 5 or the terminal 6.

[2-2] Next, the conductive adhesive composition 8 is interposed between the terminal 5 and the terminal 6 through bringing the circuit board 1 and the electronic part 2 into access while positioning the terminals 5 and 6 to be jointed. When the circuit board 1 and the electronic part 2 are brought into access, the electronic part 2 may be pressed against the circuit board 1 as needed. Use of the conductive adhesive composition of the invention 8 for the joint between the terminal 5 and the terminal 6 can suitably prevent the terminal 5 (circuit board 1 and the terminal 6 (electronic part 2 from disruption on the grounds described above.

[2-3] Next, at least a part of the solvent included in the conductive adhesive composition 8 that is present between the terminal 5 and the terminal 6 is removed in this state (see, FIG. 3B). This operation results in suppression of crystallization of the compound (1), which will be kept present in the amorphous state, owing to interaction between the substituents X. Accordingly, the viscosity of the conductive adhesive composition 8 is gradually elevated. Then, the adhesive layer 7 is formed, and the terminal 5 and the terminal 6 are jointed through elevation of the viscosity of the conductive adhesive composition 8, and still further, through solidification of the conductive adhesive composition 8.

When the adhesive layer 7 is formed, crystallized compound (1) may be also included in the conductive adhesive composition 8. In addition, method of removing the solvent included in the conductive adhesive composition 8 is not particularly limited, but may be, for example, air drying, or alternatively, forced removal such as drying by heating or vacuum drying.

As in the foregoings, the conductive adhesive composition of the invention was explained by way of exemplary embodiments illustrated in the drawings, however, it should be understood that the invention is not limited thereto.

For example, the conductive adhesive composition of the invention can be applied to the joints between the circuit board and the electronic part such as a semiconductor chip as described above. In addition, it can be applied to formation materials of, for example, electrodes mounted to electronic paper, electrophoresis display systems and the like, or through holes (conductive parts) formed in organic thin-film transistors and the like. Furthermore, in addition to possible use of the compound (1) in the aforementioned conductive adhesive composition, it can be applied to, for example, constitutional materials of antistatic agents, conductive sheets and the like, and resin binders used for retaining a functional material that achieves conductivity or any other function, and the like.

### EXAMPLES

Next, specific Examples of the invention will be explained.

1. Synthesis of Compounds

First, compounds (A) to (I) as demonstrated below were prepared.

<Compound (A)>

One mol of 4-propylaniline was dissolved in 150 mL of acetic acid, and thereto was added acetic anhydride dropwise at room temperature, followed by stirring. After completing the reaction, the deposited solid was filtrated, washed with water, and thereafter dried.

Next, 0.37 mol of the resulting substance, 0.66 mol of 1-bromo-4-methylbenzene, 1.1 mol of potassium carbonate, copper powder and iodine were mixed, and heated at 200° C. After standing the mixture to cool, thereto were added 130 mL of isoamyl alcohol, 50 mL of pure water and 0.73 mol of potassium hydroxide, followed by drying. Further, 130 mmol of thus resulting compound, 62 mmol of 4,4′-diiodobiphenyl, 1.3 mmol of palladium acetate, 5.2 mmol of t-butylphosphine, 260 mmol of t-butoxy sodium, and 700 mL of xylene were added thereto, and stirred at 120° C. Thereafter, the mixture was stood to cool thereby allowing for crystallization to obtain a compound.

Then, the resulting compound was ascertained to be the following compound (A) by a mass spectral (MS) method, a ¹H-nuclear magnetic resonance (¹H-NMR) spectral method, a ¹³C-nuclear magnetic resonance (¹³C-NMR) spectral method and a Fourier transform infrared absorption (FT-IR) spectral method.

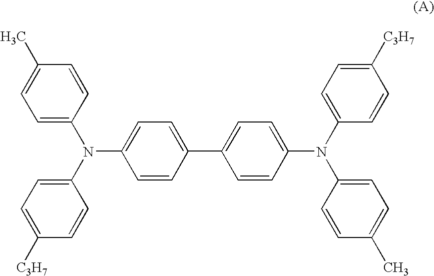

<Compound (B)>

Compound (B) was obtained similarly to the compound (A) except that 4,4′-diiodo-2,2′-dimethylbiphenyl was used in place of 4,4′-diiodobiphenyl.

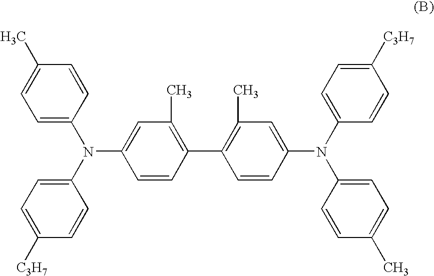

<Compound (C)>

Compound (C) was obtained similarly to the compound (A) except that 4-hexylaniline was used in place of 4-propylaniline, and 1-bromo-4-hexylbenzene was used in place of 1-bromo-4-methylbenzene.

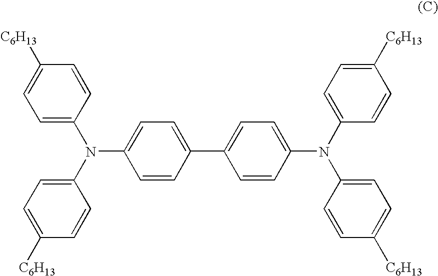

<Compound (D)>

Compound (D) was obtained similarly to the compound (C) except that 4-hexyl-3,5-dimethylaniline was used in place of 4-hexylaniline.

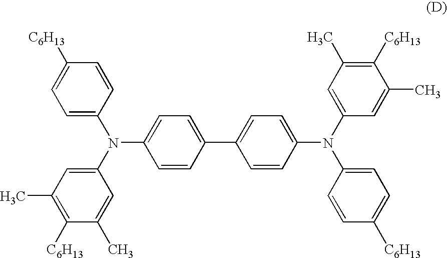

<Compound (E)>

Compound (E) was obtained similarly to the compound (A) except that 4-octylaniline was used in place of 4-propylaniline.

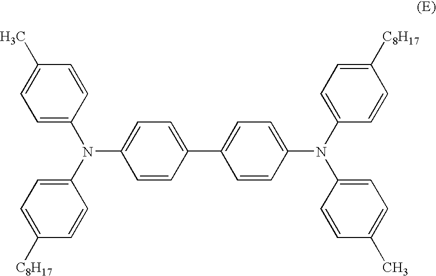

<Compound (F)>

Compound (F) was obtained similarly to the compound (A) except that 4-octylaniline was used in place of 4-propylaniline, and 1-bromo-4-hexylbenzene was used in place of 1-bromo-4-methylbenzene.

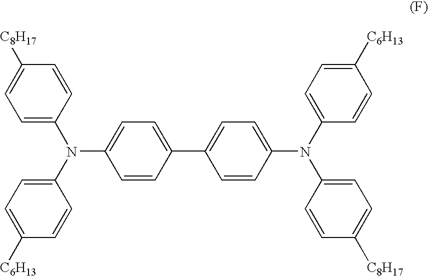

<Compound (G)>

As the following compound (G), N,N,N′,N′-tetrakis(4-methylphenyl)-benzidine (manufactured by Tosco Co., Ltd., “OSA6140”) was provided.

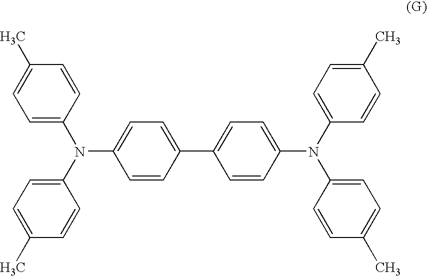

<Compound (H)>

Compound (H) was obtained similarly to the compound (A) except that 4-ethylaniline was used in place of 4-propylaniline, and 1-bromo-4-ethylbenzene was used in place of 1-bromo-4-methylbenzene.

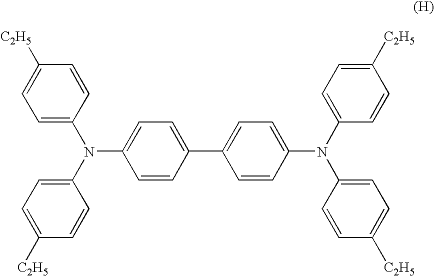

2. Preparation of Conductive Adhesive Composition of Examples 1 to 6 and Comparative Examples 1 to 2

As described below, conductive adhesive composition of each Example and each Comparative Example was prepared, respectively.

### Example 1

Using the compound (A) as a diphenylamine derivative, the compound (A) was pulverized to give the mean particle size of 0.4 mm (solid matter). Accordingly, a solid conductive adhesive composition was prepared.

### Example 2

A solid conductive adhesive composition was prepared similarly to above Example 1 except that the compound (B) was used in place of the compound (A).

### Example 3

A solid conductive adhesive composition was prepared similarly to above Example 1 except that the compound (C) was used in place of the compound (A).

### Example 4

A semisolid conductive adhesive composition was prepared using the compound (D) as a diphenylamine derivative, through dissolving the compound (D) in xylene to give the content of 10 wt %.

### Example 5

A semisolid conductive adhesive composition was prepared similarly to Example 4 except that the compound (E) was used in place of the compound (D).

### Example 6

A semisolid conductive adhesive composition was prepared similarly to Example 4 except that the compound (F) was used in place of the compound (D).

### Comparative Example 1

A solid conductive adhesive composition was prepared similarly to Example 1 except that the compound (G) was used in place of the compound (A).

### Comparative Example 2

A semisolid conductive adhesive composition was prepared similarly to Example 4 except that the compound (H) was used in place of the compound (D).

3. Evaluation

Test pieces having the conductive adhesive composition prepared in each above Example and each above Comparative Example were produced, respectively, and conductivity test and adhesive strength test were conducted on these test pieces, respectively.

3-1. Production of Test Piece

3-1-1. Production of Test Piece Having the Conductive Adhesive Composition According to Examples 1 to 3 and Comparative Example 1

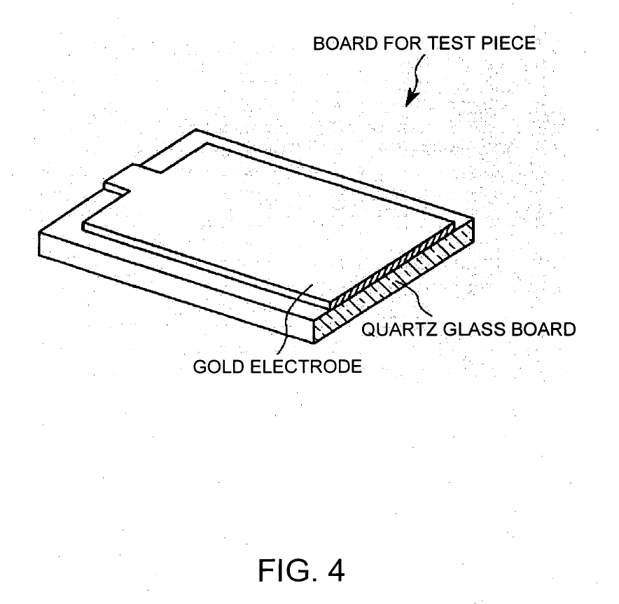

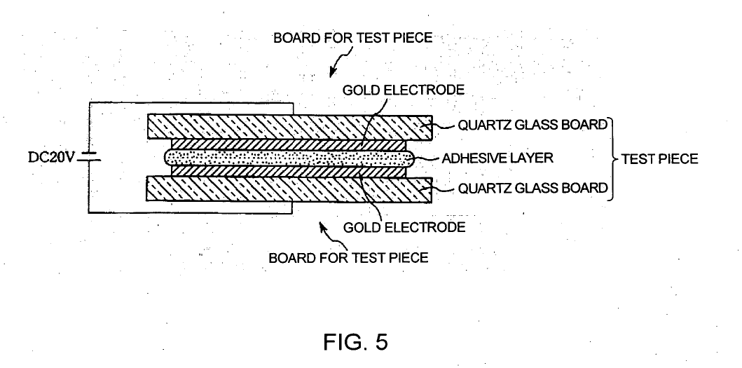

Using the solid conductive adhesive composition, ten test pieces having the conductive adhesive composition were produced as described below for each of Examples 1 to 3 and Comparative Example 1.

<1-a> First, two boards for the test piece produced by mounting a gold electrode on a quartz glass board as shown in FIG. 4 were provided.

<1-b> Next, the solid conductive adhesive composition was fed on the upper face of the gold electrode, respectively.

<1-c> Next, this conductive adhesive composition was melted by heating at 150° C. to give a transparent and colorless semisolid matter, thereby achieving adhesiveness to adhere on the upper face of the gold electrode.

<1-d> Next, one gold electrode was jointed to another by cooling in the state of the conductive adhesive composition being adhered on the gold electrode such that the gold electrodes mounted on respective boards for the test piece were opposed while allowing the semisolid matter to be interposed between the gold electrodes. Accordingly, a test piece in which the gold electrodes (boards for the test piece) were jointed via the adhesive layer as shown in FIG. 5 was obtained.

3-1-2. Production of Test Piece Having the Conductive Adhesive Composition According to Examples 4 to 6 and Comparative Example 2

Using the semisolid conductive adhesive composition, ten test pieces having the conductive adhesive composition were produced as described below for each of Examples 4 to 6 and Comparative Example 2.

<2-a> First, two boards for the test piece produced by mounting a gold electrode on a quartz glass board as shown in FIG. 4 were provided.

<2-b> Next, the semisolid conductive adhesive composition was fed (coated) by an ink jet printing method on the upper face of the gold electrode, respectively.

<2-c> Next, the conductive adhesive composition was interposed between the gold electrodes mounted on the board for the test piece by bringing the boards for the test piece into access, in the state of the semisolid conductive adhesive composition being adhered on the gold electrode such that the gold electrodes mounted on respective boards for the test piece were opposed.

<2-d> Next, the gold electrodes were jointed by heating under the condition of 150° C.×10 min in the state of the conductive adhesive composition being interposed between the gold electrodes. Accordingly, a test piece in which the gold electrodes (boards for the test piece) were jointed via the adhesive layer as shown in FIG. 5 was obtained.

3-2. Conductivity Test

Five test pieces having the conductive adhesive composition according to each Example and each Comparative Example were provided, respectively. Next, as shown in FIG. 5, power voltage of 20 V was applied to the gold electrode mounted on the test piece, and the value of electric current between the gold electrodes was measured on each Example and each Comparative Example.

The value of electric current measured on each Example and each Comparative Example is a mean value of the electric current obtained by measurement of five test pieces. Next, each test piece was left to stand in a water vapor atmosphere (temperature: 60° C., humidity: 95% RH) for 1000 hrs, and thereafter, the aforementioned conductivity test was conducted again to determine the value of electric current.

3-3. Adhesive Strength Test

Five test pieces having the conductive adhesive composition according to each Example and each Comparative Example were provided, respectively, and were attached to a jig. Then, adhesive strength test (flatwise test) was conducted on the test piece attached to the jig to give a load-crosshead distance diagrammatic view.

Next, maximum load was read from this diagrammatic view, and the adhesive strength of the adhesive layer was calculated from the maximum load on each Example and each Comparative Example. The adhesive strength calculated on each Example and each Comparative Example is a mean value of the adhesive strength calculated on each of the five test pieces.

Additionally, various conditions employed in conducting the adhesive strength test are as shown below.
Apparatus (universal material testing machine): manufactured by Instron Corporation, “Model 5565”
Measurement method: Crosshead distance method
Measurement temperature: 23° C. (room temperature)
Test speed: 0.5 mm/min

Then, evaluation was made according to the following four standards, respectively, depending on the adhesive strength calculated on each Example and each Comparative Example. Measurement of the adhesive strength of the test piece according to Comparative Example 1 could not be conducted because jointed faces were detached concomitantly with attachment to the apparatus.

A: the adhesive strength being 1.0×10⁻² MPa or greater;

B: the adhesive strength being 1.0×10⁻³ MPa or greater, and less than 1.0×10⁻² MPa;

C: the adhesive strength being 5.0×10⁻⁴ MPa or greater, and less than 1.0×10⁻³ MPa;

D: the adhesive strength being less than 5.0×10⁻⁴ MPa.

Next, each test piece was left to stand in a water vapor atmosphere (temperature 60° C., humidity: 95% RH) for 1000 hrs, and thereafter, the aforementioned adhesive strength test was conducted again to make the evaluation similarly.

These evaluation results are shown in Table 1 below.

TABLE 1

| | Conductivity test [μA] | | Adhesive strength test | |
|---|---|---|---|---|
| | Beginning | 1000 hrs later | Beginning | 1000 hrs later |
| Example 1 | 12 | 13 | B | B |
| Example 2 | 14 | 13 | B | B |
| Example 3 | 10 | 11 | A | A |
| Example 4 | 10 | 10 | A | A |
| Example 5 | 9 | 8 | B | B |
| Example 6 | 8 | 7 | A | A |
| Comparative | 15 | 13 | —*¹ | —*¹ |
| Example 1 | | | | |
| Comparative | 14 | 14 | D | D |
| Example 2 | | | | |

*¹Adhesive strength test could not be conducted.

As shown in Table 1, every one of the adhesive layer formed of the conductive adhesive composition according to each Example achieved both excellent adhesiveness and excellent conductivity. Also, even after use in a water vapor atmosphere, sufficient adhesiveness and conductivity was maintained. To the contrary, the adhesive layer formed of the conductive adhesive composition according Comparative Example 1 and Comparative Example 2 achieved excellent conductivity, however, sufficient adhesiveness could not be achieved. It is believed to be caused by the substituent X carried by the conductive adhesive composition according to Comparative Example 1 and Comparative Example 2. More specifically, it is speculated to result from impossible attainment of the interaction between the substituents X due to short chain length of the straight-chain alkyl group of the substituent X.

While this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the invention.

What is claimed is:

1. A conductive adhesive composition, comprising:
A compound represented by the following general formula (1): 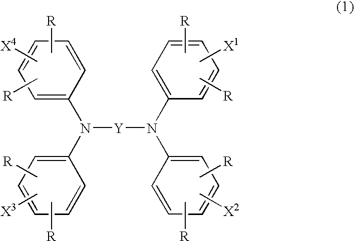
where
X¹, X², X³ and X⁴, each independently represent a hydrogen atom or a straight-chain alkyl group, which may be the same or different;
at least one of X¹, X², X³ and X⁴ representing a straight-chain alkyl group having carbon number of 3 to 8, and the rest represents a hydrogen atom, a methyl group or an ethyl group;
R at eight positions each independently representing a hydrogen atom, a methyl group or an ethyl group, which may be the same or different; and
Y represents a group including at least one substituted or unsubstituted aromatic hydrocarbon ring.

2. The conductive adhesive composition according to claim 1,
two substituents among the substituent X¹, the substituent X², the substituent X³ and the substituent X⁴ representing a straight-chain alkyl group having carbon number of 3 to 8.

3. The conductive adhesive composition according to claim 2,
the substituent X¹ and the substituent X³ representing a straight-chain alkyl group having carbon number of 3 to 8.

4. The conductive adhesive composition according to claim 2,
the substituents representing a straight-chain alkyl group having carbon number of 3 to 8 among the substituent X¹, the substituent X², the substituent X³ and the substituent X⁴ having the same carbon number.

5. The conductive adhesive composition according to claim 1,
three substituents among the substituent X¹, the substituent X², the substituent X³ and the substituent X⁴ representing a straight-chain alkyl group having carbon number of 3 to 8.

6. The conductive adhesive composition according to claim 5,
the substituents having a straight-chain alkyl group having carbon number of 3 to 8 among the substituent X¹, the substituent X², the substituent X³ and the substituent X⁴ having the same carbon number.

7. The conductive adhesive composition according to claim 1,
all of the substituent X¹, the substituent X², the substituent X³ and the substituent X⁴ representing a straight-chain alkyl group having carbon number of 3 to 8.

8. The conductive adhesive composition according to claim 7,
all of the substituent X¹, the substituent X², the substituent X³ and the substituent X⁴ having the same carbon number.

9. The conductive adhesive composition according to claim 1,
the substituent X¹, the substituent X², the substituent X³ and the substituent X⁴ binding to either one of the position 3, position 4 or position 5 of the benzene ring, respectively.

10. The conductive adhesive composition according to claim 1,
the group Y being constituted from a carbon atom and a hydrogen atom.

11. The conductive adhesive composition according to claim 1,
the group Y having total carbon number of 6 to 30.

12. The conductive adhesive composition according to claim 1,
a number of the aromatic hydrocarbon ring in the group Y being 1 to 5.

13. The conductive adhesive composition according to claim 1,
the group Y being a biphenylene group or a derivative thereof.

14. The conductive adhesive composition according to claim 1,
the compound having a melting point of 60 to 150° C.

15. The conductive adhesive composition according to claim 1,
the compound having a glass transition temperature of 5 to 30° C.

16. The conductive adhesive composition according to claim 1 which is used as a solid matter comprising the compound as a principal component.

17. The conductive adhesive composition according to claim 16,
the solid matter achieving adhesiveness upon heating.

18. The conductive adhesive composition according to claim 1,
the compound being dissolved in a solvent, and being used as a liquid matter or a semisolid matter.

19. The conductive adhesive composition according to claim 18,
the liquid matter and the semisolid matter achieving adhesiveness through removal of at least a part of the solvent.

20. The conductive adhesive composition according to claim 18,
the content of the compound in the liquid matter and the semisolid matter being 1 to 50 wt %.
